(19) United States
(12) Patent Application Publication
(10) Pub. No.: US 2014/0056020 A1
(43) Pub. Date: Feb. 27, 2014

(54) LIGHT UNIT FOR A MOTOR VEHICLE

(71) Applicant: Hella KGaA Hueck & Co., Lippstadt (DE)

(72) Inventors: Carmen Bungenstock, Kleinenberg (DE); Carsten Hohmann, Warstein (DE); Martin Mügge, Geseke (DE); Alfons Puls, Soest (DE); Thomas Vieregge, Dortmund (DE)

(73) Assignee: Hella KGaA Hueck & Co., Lippstadt (DE)

(21) Appl. No.: 13/972,605

(22) Filed: Aug. 21, 2013

(30) Foreign Application Priority Data
Aug. 21, 2012 (DE) 102012107644.8

(51) Int. Cl. F21S 8/10

(52) U.S. Cl. CPC F21S 48/115
USPC 362/549; 362/459

(57) ABSTRACT

A light unit for a motor vehicle with an illuminated area through which visible light can be emitted. The illuminated area is formed by a first and a second planar OLED-element and the first OLED-element can be controlled independent from the second OLED-element, thus a segmenting of the illuminated area occurs.

### CROSS REFERENCE

This application claims priority to German Patent Application No. 10 2012 107644.8, filed Aug. 21, 2012, which is expressly incorporated in its entirety by reference herein.

### TECHNICAL FIELD OF THE INVENTION

The invention relates to a light unit for a motor vehicle with a lighting unit according to the preamble of claim 1.

### BACKGROUND OF THE INVENTION

The use of light units in a motor vehicle, particularly headlights and tail lights, is known. Here, two common illuminants are used. On the one hand, a light bulb is used as a standard light source. It may show various shapes, sizes and different light beams, so that a suitable light bulb can be selected for each application. In general, light bulbs emit white light, however by way of coating the glass bulb or by additional colored disks or exterior panes colored, particularly yellow or red light can be emitted. On the other hand, light diodes can be used. A light diode comprises several layers of semi-conductive material. When the diode is operated in the forward direction, light is generated in a thin layer, the active layer. Contrary to light bulbs, which emit a continuous spectrum, LED light emits light of a certain color. The color of the light depends on the material used. Two material systems (AllnGaP and InGaN) are used in order to generate LEDs with strong luminosity in all colors from blue to red, as well as white (by luminescence conversion or phosphorous conversion). In light bulbs it is disadvantageous that they show a considerable size and adjacent parts, such as reflector areas or chamber walls of a functional space, must maintain a large distance from the light bulb for thermal reasons. Furthermore it is disadvantageous that the use of light bulbs in connection with fiber-optic devices is difficult and limited to larger fiber-optic devices. The disadvantage of an LED is the fact that it represents a small, dot-shaped light source.

Any consistent, planar emission of the LED, including the use of several LEDs, is not possible without additional means. This also applies for the use of a light bulb. Several optic systems are used in the light unit in order to generate a large illuminated area using a light bulb or a LED, particularly reflectors, lens systems, or fiber-optic systems. Here, the light unit shows an illuminated area, from which the visible light of the illuminant can be emitted. Two items have proven disadvantageous. On the one hand, the optic systems used in the motor vehicle use additional installation space and, on the other hand, it is not possible allowing only partial sections of the illuminated area, allocated to a light source, to emit visible light.

### SUMMARY OF THE INVENTION

The objective of the present invention is to provide a light unit for a motor vehicle, with the light unit being designed in a simple and reliable fashion. In particular, another objective of the present invention is to provide a light unit with a small installation space. Additionally, another objective of the present invention in particular is to provide a light unit allowing a high degree of design freedom.

In order to attain this objective, a light unit is suggested showing all features of claim 1, particularly the features of the characterizing part. The dependent claims show preferred further developments. Here, the features mentioned in the claims and in the description may separately or in combination be essential for the invention.

The invention discloses a light unit for a motor vehicle with an illuminated area, by which visible light can be emitted. The term illuminated area shall be understood as the area by which the emittable light of the light unit can be emitted. According to the invention here it is provided that the illuminated area is formed by at least a first and a second planar OLED-element and that the first OLED-element can be controlled independent from the second OLED-element, resulting in a segmenting of the illuminated area.

Planar OLED-elements offer the decisive advantage that the visible light can be emitted homogeneously over the entire area of the OLED-element. The use of optic systems to obtain a homogenous emission over the illuminated area, which is required according to the state of the art for LEDs or light bulbs, can be omitted. Furthermore, less installation space is required for the entire light unit in reference to state of the art. Additionally, segmenting the illuminated area offers the advantage of not requiring the use of the entire illuminated area for emitting visible light. This way, the light unit can perform various signal functions. An OLED is characterized in representing a planar light source and can be used as a directly emitting planar radiation emitter for illuminating functions. The OLED may show an arbitrary area and contour, based on the installation conditions. It emits light in the shape of cosines into the half-space. Further it is possible to use additional optic systems directly on the OLED-area in order to bundle the light to a greater extent in the direction of the surface normal. Ideally the OLED-area can be installed perpendicular in reference to the primary direction of the light beam to fulfill a signal function and a light distribution. Therefore the use of planar OLED-elements offers new options of installation for said signal functions, e. g. in tail lights or headlights of a motor vehicle, as well as in lights for general illumination. Here, the planar OLED-element may be selected freely with regards to size and design. Thus, for example the stylistic conditions and those determined by the technical space available for the tail light or the headlight, in which a signal function shall be installed, can be considered.

It is particularly advantageous that the first OLED-element is arranged off-set with regards to depth in reference to the second OLED-element, allowing a three-dimensional depth effect. A three-dimensional depth effect offers the advantage that the signal effect e. g. of a brake light is increased in reference to an evenly illuminated area. Additionally, the same technical three-dimensional signal effect can be generated with a small installation space, without requiring any expensive optic systems.

Furthermore it is advantageous that the first and/or the second OLED-element are embodied opaque or transparent. This way, opaque and transparent OLED-elements can alternate in the sequence of the arrangement in order to achieve different transmissions of the emitted light. Accordingly different optic effects can be achieved. Additionally it is possible to provide the opaque and transparent OLED-elements with energy in an alternating manner. Thus the illuminated area can be used for two different light functions. In particular it is possible to trans-illuminate the transparent OLED-elements by another illuminant arranged behind it, e.g. a LED-light , and thus to integrate another light function, which may be implemented in a different color. Of course, the entire light function may also be formed from several identical opaque or transparent OLED-elements. Furthermore it is advantageous that the segmenting of the illuminated area can be adjusted to the requirements of the overall light function. In particular, the segmenting can occur such that it extends in a predetermined progression over several OLED-elements, perhaps arranged off-set, thus allowing an individual segmenting. In the most simple case each illuminated area can also occur by identical segmenting of the OLED-elements, requiring only one OLED-layout to be manufactured.

It is advantageous that the first OLED-element at least partially covers the second OLED-element. The first OLED-element can here be transparent and the second OLED-element opaque. This way it is possible that the emitted visible light of the second OLED-element can pass through the first OLED-element. This way three different light sections can be generated. In the event that the first and the second OLED-element are supplied with energy simultaneously, three different light sections develop. The first section is equivalent to the first OLED-element, which is not covered by the second OLED-element. The second section relates to the second OLED-element overlapping the first OLED-element. The third section is the part of the second OLED-element, which is not covered by the first OLED-element. This way three different light effects can be generated by two OLED-elements. These light effects can be used for different signal functions in a motor vehicle.

It is advantageous for the first OLED-element and the second OLED-element to emit visible light of different wavelengths. This way it is possible for the illuminated area to fulfill two different functions, e. g. the function of a brake light and the function of a turn signal. Accordingly, the first OLED-element can emit red light, while the second OLED-element can emit yellow light. Accordingly the illuminated area can be divided into different functional segments without any optic systems.

Furthermore it is advantageous for the first and/or the second OLED-element to be dimmable. This way it is possible that only the first OLED-element is dimmed. Additionally, a different dimming of the first and the second OLED-element is possible. Through this different light scenarios can be generated, which may lead to different signal effects. By a gradual progression of brightness due to dimming, the appearance of a perspective depth of the signal function, as example, can be generated. In this scenario, the first and the second OLED-element can be arranged on the same level in reference to each other. This way, the OLED-elements depth off-set can occur. The effect of a gradual dimming and a geometric depth off-setting of the OLED-elements can be used in combination, to generate a particularly intense depth effect of the signal function.

It is advantageous for the first OLED-element to be spaced apart from the second OLED-element. Through this the illuminated area can be segmented by the first and the second OLED-element in such a manner that the distance of the OLED-elements is hardly visible to the observer. Alternatively, by a defined, greater distance of the first and second OLED-element of an illuminated area, an unlit separating strip can be generated.

It is particularly advantageous that the first and/or the second OLED-element shows a contour design which is circular, rectangular, triangular, hexagonal, octagonal, polygonal, trapezoidal, or in any freely designed contour. With this it is possible that the illuminated area can assume different geometric designs. It is also possible to off-set the first and the second OLED-elements so that several illuminated areas can be arranged separated from each other.

It is advantageous for the first and/or the second OLED-element to include an electric contact element, with the electric contact element being arranged at the rear or an edge side of the first and/or the second OLED-element. An arrangement of the contact element on the rear of the OLED-element allows that the illuminated area stretched by the first and/or the second OLED element can be used directly abutting in an installation space. This way, a gap measure between the installation space and the illuminated area can be effectively prevented. Additionally, a simple assembly of the illuminated area is possible in the installation space of a motor vehicle.

Furthermore, it is advantageous that at least one fastening element is provided, by which the light unit can be fastened at the motor vehicle. The light unit also includes means to affix the first and the second OLED-element in their desired position. The means used may include an adhesive or a screw connection or a latching connection. Additionally, fastening elements may be arranged at the light unit in order to fasten the light unit at the motor vehicle. This may relate to eyelets, where the light unit can be fastened to the motor vehicle in a force and/or form-fitting fashion by using a fastening measure, such as a bolt. Additionally, latching hooks are also possible as fastening elements, which engage a complementary counter means, e.g., a latching area applied at the motor vehicle, generating a detachable form-fitting and/or force-fitting connection. A welding or adhesive method is also possible, by which the light unit can be attached to the motor vehicle.

These aspects are merely illustrative of the innumerable aspects associated with the present invention and should not be deemed as limiting in any manner. These and other aspects, features and advantages of the present invention will become apparent from the following detailed description when taken in conjunction with the referenced drawings.

### BRIEF DESCRIPTION OF THE DRAWINGS

Reference is now made more particularly to the drawings, which illustrate the best presently known mode of carrying out the invention and wherein similar reference characters indicate the same parts throughout the views.

FIG. 1 a schematic illustration of first and second OLED-elements,

FIG. 2 a schematic illustration of first and second OLED-elements arranged concentrically,

FIG. 3 a schematic illustration of first and second OLED-elements along a curved line,

FIG. 4 a schematic illustration of a light unit with a first and second OLED-element,

FIG. 5 a schematic illustration of a partial covering of a first and a second OLED-element,

FIG. 6 a schematic illustration of a geometric form of a light unit with a first and a second OLED-element,

FIG. 7 a schematic illustration of a light unit with three OLED-elements,

FIG. 8 a schematic illustration of a light unit with a first and a second OLED-element,

FIG. 9 a schematic illustration of a first and a second OLED-element around a circular illuminated area,

FIG. 10 a schematic illustration of several first and second OLED-elements, which partially overlap each other, and

FIG. 11 a schematic illustration of first and second OLED-elements around a semicircular OLED-element.

### DETAILED DESCRIPTION

In the following detailed description numerous specific details are set forth in order to provide a thorough understanding of the invention. However, it will be understood by those skilled in the art that the present invention may be practiced without these specific details. For example, the invention is not limited in scope to the particular type of industry application depicted in the figures. In other instances, well-known methods, procedures, and components have not been described in detail so as not to obscure the present invention.

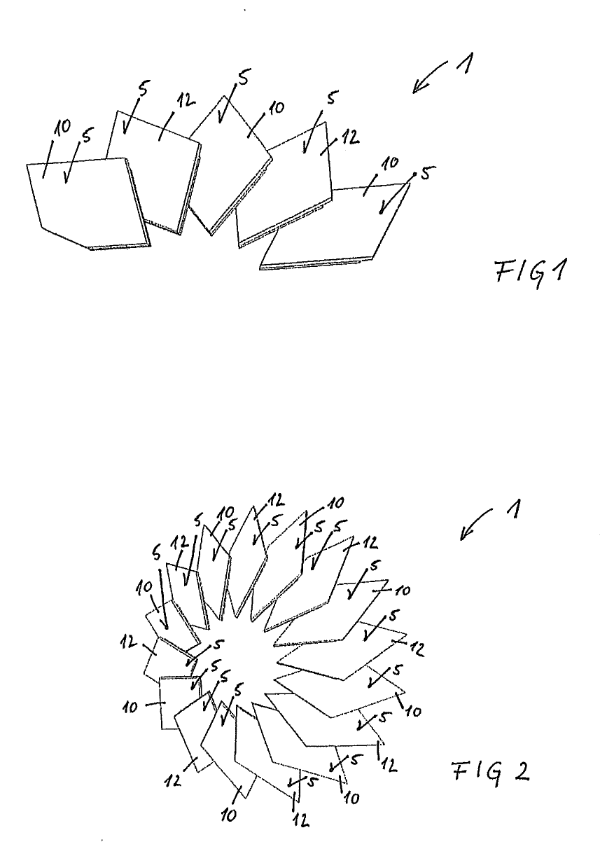

FIG. 1 shows first 10 and second OLED-elements 12, which partially overlap each other and form an illuminated area 5. The size and shape of the first 10 and second OLED-elements 12 can be selected freely in order to consider the stylish framework conditions and those technically determined by installation space of a predetermined tail light or a headlight, in which signal functions shall be installed. The OLED-elements 10, 12 may be circular, square, rectangular, triangular, hexagonal, octagonal, trapezoidal fashion, or showing a freely formed contour. When the first 10 and the second OLED 12 is predetermined with regards to shape and size, this design can be arranged repeatedly side-by-side in order to yield a desired appearance. The shape and size may be executed and adjusted to achieve the desired optimal, homogenous appearance of the OLED-arrangement. FIG. 2 shows as an example a schematic illustration of first 10 and second OLED-elements 12 arranged concentrically, with the OLED-elements 10, 12 being arranged circularly. The individual OLED-elements 10, 12 partially cover each other. This way a concentric appearance can be generated. It is not required for the individual OLED-elements 10, 12 to be arranged perpendicular in reference to the driving direction, but may be arranged horizontal and/or vertical. The OLED-elements 10, 12 can be formed in a manner that they precisely abut in the projection. Additionally, they may be offset with regards to depth or also slightly overlap in their projection. Depending on the usage of opaque or transparent OLED-elements 10, 12, different light and illuminating effects and/or 3D-effects of the signal function develop. The OLED-elements 10, 12 may be used in an opaque or transparent form. They may alternate in their sequence of arrangement. Additionally, it is possible for the OLED-elements 10, 12 to be arranged so that the rear row is executed with opaque OLED-elements 10, 12 and a front row, partially covering the rear row, comprising transparent OLED-elements 10, 12.

This way the emitted light of the rear, opaque row of OLED-elements may also trans-illuminate and be visible through the transparent OLED-elements 10, 12. In order to design a signal function, the OLED-elements 10, 12 do not necessarily need to be arranged concentrically. Rather, they can be arranged arbitrarily, according to the space available for the light and/or the headlight, and for example be shown in a straight line or a curved line, as illustrated in FIG. 3. This way, once the shape and size of an OLED-element 10, 12 has been selected, a plurality of different signal functions and stylistic arrangements can be implemented. Through this the expense for development and production of OLED-elements 10, 12 can be reduced, because several base elements of an OLED-element 10, 12 can generate arbitrary numbers of different embodiments of a signal function. Thus, OLED-elements 10, 12 are provided, which are divided into two or more segments, with the individual segments may emit light of the same color, for example red. Additionally segments may be used with different colors, for example, red and yellow or white and yellow segments. This offers the advantage that in a modular arrangement of the OLED-elements 10, 12, even dual functions of a tail light or a headlight can be supported, with the increase in area of the illuminated area being used striking for the observer and promoting traffic safety.

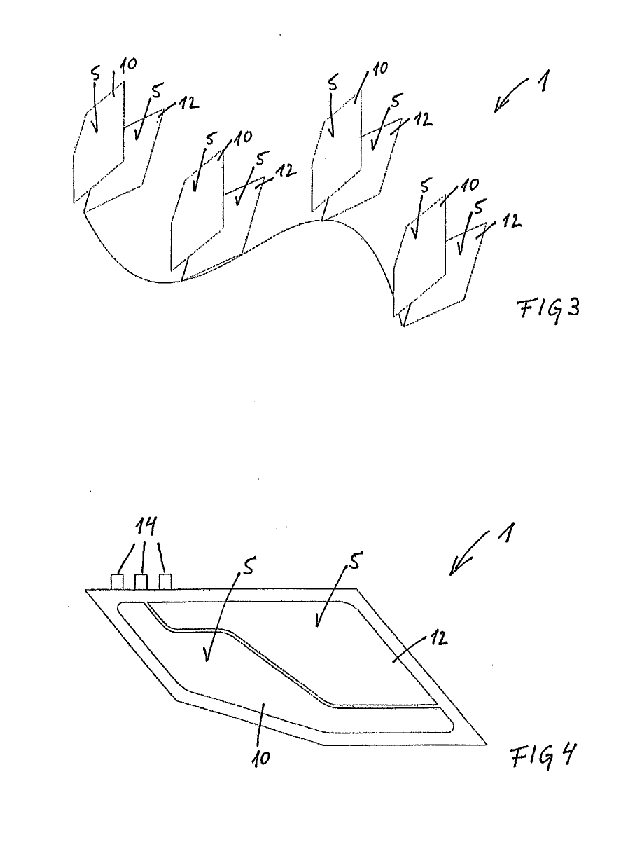

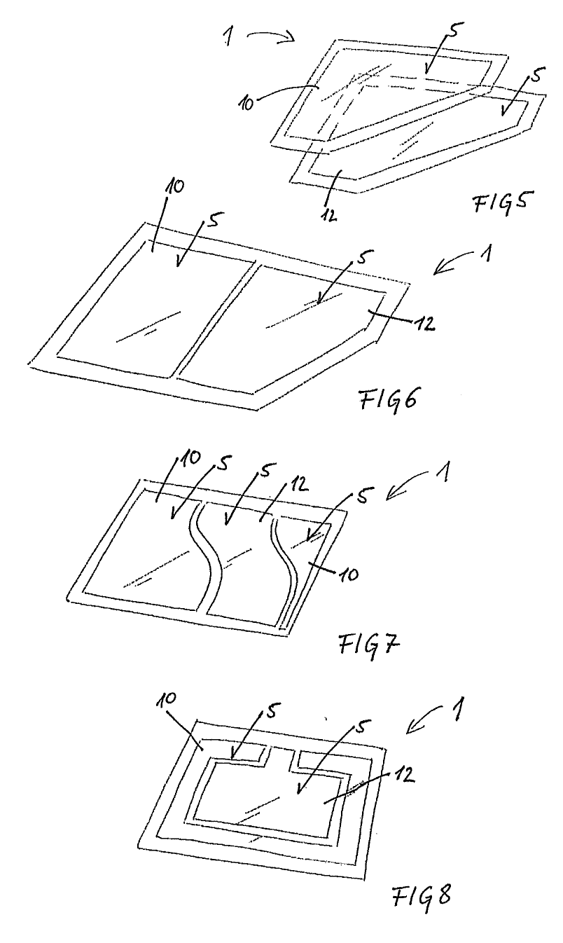

FIG. 4 shows a schematic design of a light unit, with the light unit comprising a first 10 and a second OLED-element 12. The contact elements 14 of the first 10 and the second OLED-element 12 are provided at the edge of a common carrier, with the first 10 and the second OLED-element 12 being arranged on the carrier. Advantageously the contact elements may also be attached to the rear of the carrier. The first OLED-element 10 can emit yellow light, thus allowing it to be used as a turn signal. Possible embodiments of the first 10 and the second OLED-elements 12 are shown in FIGS. 5 to 8. The second OLED-element 12 can emit red light, with the second OLED-element 12 being operated as a tail light or a brake light. It is particularly striking that the first OLED-element 10 and the second OLED-element 12 can be arranged with a very narrow measured gap side-by-side, as clearly discernible from FIGS. 4, 6, 7, and 8.

It is also possible that the first 10 and the second OLED-element 12 emit red light. For a tail light with low light requirements, initially only the first OLED-element 10 is addressed, with the second OLED-element 12 being added for the brake light. Here, a combined tail light and brake light function can be provided, where within the tail light operation, both the central LED-function is lit, in connection with a Fresnel lens, and the second function is generated by a first 10 and a second OLED-element 12. By the two-fold enlargement of the area, inwardly by the Fresnel lens and outwardly by the complete OLED-circle, a clear warning effect of the brake light signal can be achieved. This principle can also be transferred from a white OLED-element 10, 12, used as a positioning light, which only needs low light values, to a daytime driving light, which requires high light values, as a combined light function of a headlight. The LED-function can be executed as an arbitrary optic system, for example as a Fresnel optic, as reflectors, or a fiber-optic systems. This also depends on the design and the requests of the respective light and/or headlight design. The central function may also be formed by an OLED-element. In case of different colors of the OLED-elements 10, 12, additional functional combinations can be realized. For example, a partial section of each OLED-unit 10, 12 may illuminate in red as a tail light, and a second partial section can illuminate in yellow, together with another LED-function, as a turn signal. This can also be used with the colors white and yellow for a combined position-indicating blinking light in a headlight. An OLED-element 10, 12 can here be divided into two or more light segments.

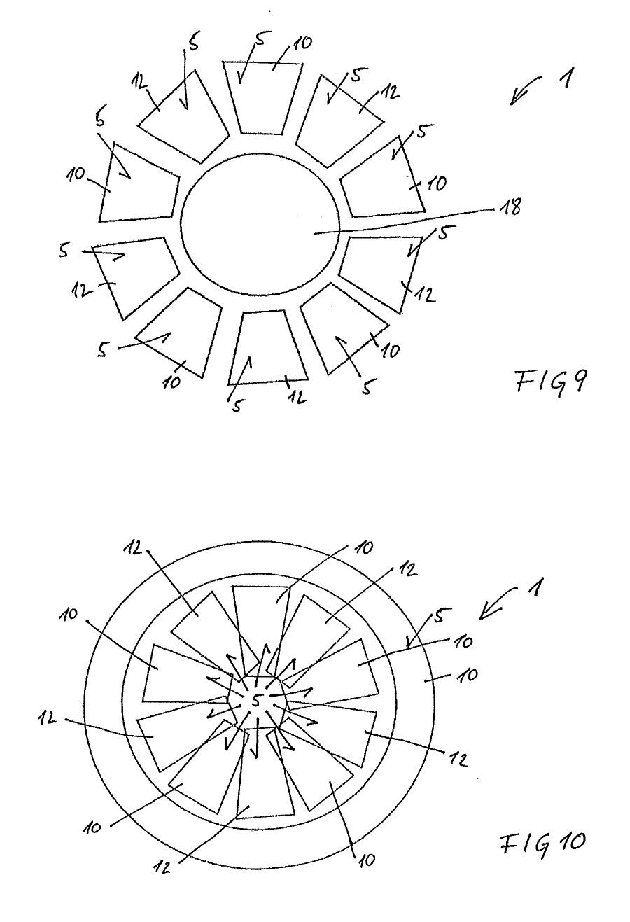

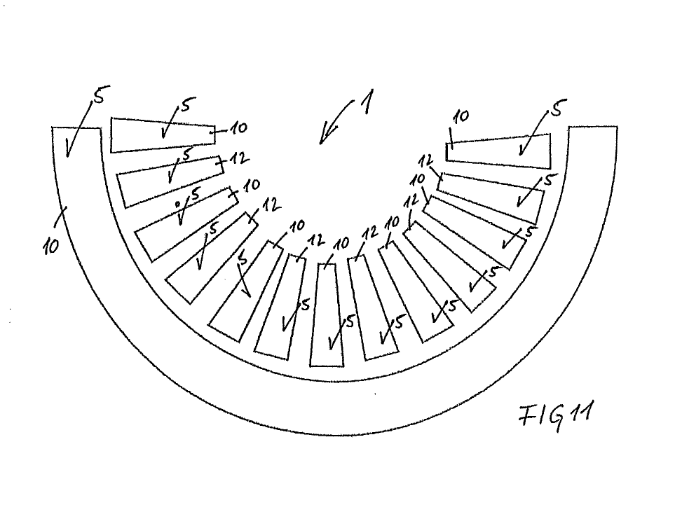

FIG. 9 shows a combination of an OLED-function with first 10 and second OLED-elements 12 and a LED-function 18. High luminosity can be provided by this arrangement. Here, the LED-function can be executed, depending on the stylish integration of the overall function within an OLED-arrangement, outside an OLED-arrangement, or parallel to an OLED-arrangement. In FIGS. 9 to 11 it shows schematically how OLED-elements 10, 12 can be divided, not only into two partial sections, or three, or four identical sections, but with their illuminated area being embodied graphically, which means the segments may also show curved edge contours.

Furthermore, using such an arrangement of OLED-elements 10, 12, it is possible via technical circuitry to address them so that similar to conventional signal functions, the function overall can be switched on and/or off, meaning all segments can be switched on or off simultaneously. Alternatively, an activation can occur so that the OLED-elements 10, 12 are switched successively in a rapid sequence during the switching process, meaning the function is lit in the form of a running light. Similarly the function can be segmentally switched off, during the switch-off process, so that a running light in the opposite direction develops. Additionally, the OLED-elements 10, 12 can also be controlled in a differently dimmed fashion, in order to generate a progressing brightness in the sequence of the OLED-elements 10, 12. For example, the impression of a perspective depth of the signal function can be generated by a gradually progressing brightness. When two or more illuminated segments are used, it is possible to dim only a portion of the segments lit, to include a different extent of dimming, and to operate other segments at frill luminosity, in order to generate different light scenarios.

1. A light unit for a motor vehicle with an illuminated area, by which visible light can be emitted, comprising:
at least a first and a second planar OLED element comprising the illuminated area, and
wherein the first planar OLED-element is operable for independent control from the second planar OLED-element, allowing a segmenting of the illuminated area.

2. The light unit according to claim 1, wherein the first planar OLED-element is arranged off-set in a depth in reference to the second planar OLED-element, allowing a three-dimensional depth effect.

3. The light unit according to claim 1, wherein the first or the second planar OLED-element is opaque or transparent.

4. The light unit according to claim 1, wherein the first planar OLED-element at least partially covers the second planar OLED-element.

5. The light unit according to claim 1, that the first and second planar OLED-elements are operable for emitting visible light of different wavelengths.

6. The light unit according to claim 1, wherein the first or the second planar OLED-element are operable for dimming.

7. The light unit according to claim 1, wherein the first planar OLED-element is arranged at a distance from the second planar OLED-element.

8. The light unit according to claim 1, wherein the first or the second planar OLED-element is provided with a design contour, selected from the group consisting of circular, rectangular, triangular, hexagonal, octagonal, polygonal, trapezoidal, or a freely formed contour.

9. The light unit according to claim 1, wherein the first or the second planar OLED-element comprise an electric contact element, with the electric contact element being arranged at the rear or an edge side of the first or the second OLED-element.

10. The light unit according to claim 1, further comprising at least one fastening element to fasten the light unit at the motor vehicle.
